(19) United States
(12) Patent Application Publication
(10) Pub. No.: US 2025/0284887 A1
(43) Pub. Date: Sep. 11, 2025

(54) Process for Delimiter-Tolerant Adaptive Parsing using Variable Tokens

(71) Applicant: Jerry Tan, Stony Brook, NY (US)

(72) Inventor: Jerry Tan, Stony Brook, NY (US)

(21) Appl. No.: 18/596,891

(22) Filed: Mar. 6, 2024

(51) Int. Cl. G06F 40/284; G06F 40/205

(52) U.S. Cl. CPC G06F 40/284; G06F 40/205

(57) ABSTRACT

This invention presents an adaptive parsing system with a processor designed to enhance text data structuring. It initiates parsing with a default delimiter, adjusting to extra delimiters by employing variable tokens, thereby optimizing the parsing strategy for diverse data formats. The system trims whitespace, categorizes tokens, and resolves ambiguities using heuristic rules and a machine learning model trained on previously parsed tokens. A user interface allows for manual correction, feeding back into the model for continuous improvement. The parsed data is output in structured formats (JSON, XML, CSV), suitable for various database systems. Integrated into a larger data processing framework, it provides real-time feedback and supports scalability and collaboration in cloud environments. This adaptive approach to parsing addresses data format diversity, ensuring accuracy and efficiency in data interpretation.

### PRIOR ART

Automated text parsing plays a critical role in various applications, including language translation and voice recognition.

Parsing involves analyzing and decomposing a sentence into its constituent parts, such as noun phrases, verb phrases, and prepositional phrases.

Such phrases, which can be nested within each other, form the building blocks of clauses and sentences.

However, such automated text parsing systems historically struggle with ambiguity in sentence parsing, which can lead to misinterpretations without the context provided by adjacent sentences or the broader text.

Consequently, such existing systems that rely solely on algorithmic parsing of text without human intervention are suboptimal.

In particular, such prior art is significantly challenged by:
The inherent ambiguities in language that automated systems find difficult to resolve.
The complexity of hierarchical lists that represent sentence structures often render them difficult to comprehend, or review accurately.
The textual nature of such lists often results in user fatigue, which then predictably leads to an increase in oversight of simple errors during the review or correction process.

Moreover, the vast majority of prior art fails to adequately address the need for a more intuitive and user-friendly interface that can facilitate the accurate review and correction of parsed text.

While some prior art does attempt to resolve this deficiency by addressing this distinct absence of systems that leverage graphical representations to enhance user interaction and comprehension, the current Invention can enhance the accuracy of automated parsing corrections without necessarily relying on any graphical user interface.

Examples of such prior art include, but is not limited to, U.S. Pat. Nos. 5,802,533; 6,279,017; 7,036,075; 7,765,471; and 7,861,163.

Some prior art even introduces algorithms that can generate hierarchical lists for parsing sentences into their constituent clauses.

While these algorithms do achieve impressive degrees of high accuracy, they are often limited by their reliance on text-based representations, which can be challenging for users to review let alone correct.

Thus, errors are easily overlooked, and therefore propagate.

Moreover, the correction process can be tedious, time-consuming, and error prone.

### BACKGROUND OF THE INVENTION

The present Invention introduces a novel parsing correction system characterized by delimiter tolerance in conjunction with variable tokens.

Specifically, neither any explicit reliance or dependence is needed for any graphical user interface, nor is one ruled out either.

Thus, this system not only addresses the limitations of text-based review by making sentence structures easier to understand and interact with but also converts these interactions into machine-readable markup for further processing.

This approach significantly enhances the accuracy of parsing corrections and introduces new possibilities for document reading and building, offering extensive customization options and multimodal interaction capabilities.

### SUMMARY OF THE INVENTION

The Invention pertains to the domain of automated parsing systems, which are typically machine-implemented.

Specifically, it focuses on the perennial problem of text parsing by introducing a novel correction mechanism.

This system is distinguished by its incorporation of a process that imbues delimiter tolerance, when used in conjunction with variable tokens.

Notably, any graphical interface that permits user interaction for the adjustment and reconfiguration of graphical elements is not explicitly ruled out, but neither is any graphic user interface required.

The automated process whereby delimiter tolerance is introduced promotes interactions that facilitate the creation of coordinated relationships among parsed text and elements, which are then encoded into hierarchical machine-readable markup code.

This innovation addresses the need for improved accuracy and user engagement in automated text parsing systems, replete with built-in auto-correcting capabilities.

### BRIEF DESCRIPTION OF DRAWINGS

FIG. 1 illustrates a flowchart depicting a standard parsing process, beginning with the specification of a delimiter and concluding with the final parsed output.

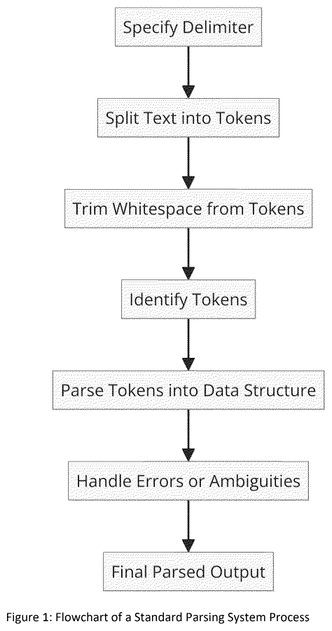

FIG. 2 shows a flowchart for an adaptive parsing process that starts with adaptive parsing, performs a first pass using a default delimiter, checks for extra delimiters, and depending on the findings, either proceeds with the default delimiter or initiates a second pass with adaptive parsing using variable tokens, ultimately leading to the final parsed output.

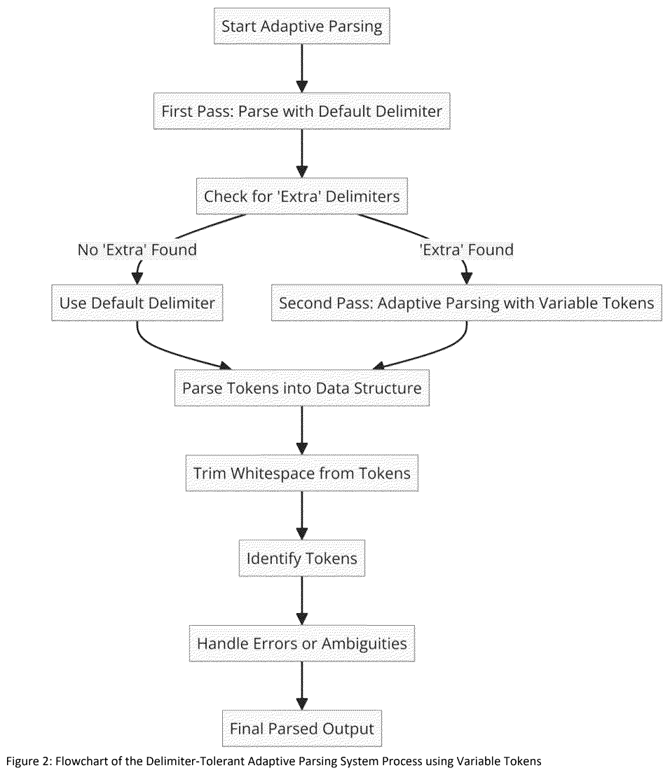

### DETAILED DESCRIPTION OF THE INVENTION

The present invention relates to an adaptive parsing system designed to interpret and structure text data dynamically using variable tokens.

The adaptive parsing process begins with a default parsing attempt using predefined delimiters.

Upon encountering an ‘extra’ delimiter that falls outside the expected range, the system initiates a second parsing phase.

This adaptive phase accommodates variable tokens, adjusting parsing strategies to effectively manage diverse data formats.

The system parses the tokens into a data structure, trims whitespace to ensure data cleanliness, identifies the tokens according to predetermined categories, and handles any errors or ambiguities that arise.

The final output is a structured representation of the initially unstructured text data.

Saliently, the present invention introduces an innovative adaptive parsing system that significantly enhances the interpretation and organization of text data by dynamically utilizing variable tokens.

This innovative system is engineered to address the challenges posed by diverse data formats, ensuring high accuracy and efficiency in parsing unstructured text into a well-organized data structure.

At the core of the invention is a sophisticated parsing process that begins with an initial attempt using a set of predefined delimiters.

This standard phase is designed to handle conventional text structures effectively.

However, the true innovation lies in the system's capability to adapt when it encounters an ‘extra’ delimiter, which deviates from the expected delimiter range.

Such anomalies trigger the adaptive parsing phase, a novel mechanism that introduces flexibility in handling variable tokens.

This phase is crucial for adjusting the parsing strategy on-the-fly to accommodate various data formats, making the system remarkably versatile.

During this adaptive phase, the system employs advanced algorithms to parse the tokens into a meticulously structured data framework.

It meticulously trims whitespace to maintain data integrity and cleanliness, ensuring that the output is both accurate and user-friendly.

Moreover, the system classifies tokens into predetermined categories, enhancing the interpretability of the data.

Throughout this process, the system is equipped with robust error handling capabilities and is adept at resolving ambiguities, thereby significantly reducing the potential for misinterpretation of the data.

A quintessential example of the system's capability to resolve ambiguities can be illustrated by its handling of the sentence “The old man the ship.”

At first glance, this sentence presents a linguistic puzzle that could lead to two distinct interpretations.

The first possible interpretation is “The old man [commands/operates] the ship,” where “man” is used as a verb, suggesting that an elderly individual is in charge of the ship.

The second interpretation could be “The old man [is aboard] the ship,” with a more passive connotation implying the presence of an elderly man on the ship.

The adaptive parsing system tackles this ambiguity by analyzing the context surrounding the sentence, both preceding and following it.

If the text leading up to this sentence discusses activities related to operating or commanding a ship, the system is more likely to interpret “man” as a verb, aligning with the first interpretation.

Conversely, if the surrounding text describes passengers or individuals on the ship, the system leans towards the second interpretation, viewing “man” as indicating the presence of an individual.

This example underscores the system's profound ability to not only detect ambiguities but also intelligently infer the most likely intended meaning by considering contextual clues.

Such adaptive parsing not only enhances text data interpretation but also paves the way for more nuanced and accurate data analysis, reflecting the innovative spirit and technical advancement embodied in the present invention.

Consequently, the Invention disclosed herein pertains to an adaptive parsing system capable of intelligently structuring text data by utilizing a dynamic parsing approach that adapts to variable tokens.

The system initiates parsing with a default delimiter and checks for the presence of unexpected, or ‘extra’, delimiters.

If extra delimiters are detected, the system shifts to an adaptive mode that implements variable tokens, enhancing the flexibility and accuracy of parsing across diverse text formats.

Post parsing, the system trims whitespace, categorizes tokens, and resolves any arising errors or ambiguities, culminating in a clean, structured data output.

This Invention provides significant improvements in automated data processing, especially when dealing with heterogeneous data sources.

Saliently, the present Invention introduces an advanced adaptive parsing system that revolutionizes the way text data is interpreted and structured.

At the heart of this system lies a sophisticated processor capable of initiating parsing operations by applying a default delimiter to text input.

This system is uniquely designed to identify and adapt to extra delimiters that fall outside the scope of the default delimiter, employing variable tokens to enhance the parsing process.

These variable tokens are ingeniously derived from patterns observed in the occurrences of extra delimiters, enabling the system to dynamically adjust its parsing strategy to accommodate a wide array of data formats.

A significant feature of this system is its ability to trim whitespace from tokens following the adaptive parsing phase, ensuring data cleanliness and integrity.

The processor categorizes tokens into predefined types, thereby simplifying data analysis and interpretation.

In the face of errors or ambiguities, the system employs a set of heuristic rules, configurable based on the text's context, to resolve ambiguities.

This flexibility is further enhanced by the incorporation of a machine learning model trained on a dataset of previously parsed tokens, allowing for the prediction of ambiguous token categories with remarkable accuracy.

The system is also consistent with one which features a user interface that not only facilitates manual correction of parsing errors but also provides suggestions for possible corrections based on historical parsing data.

User corrections are recorded to continually refine the machine learning model, ensuring that the system evolves and improves over time.

The output of the parsed data is presented in a structured format compatible with various database systems, including JSON, XML, and CSV formats, thereby providing flexibility in data utilization.

Integrated within a larger data processing system that includes data analytics tools, the invention offers real-time feedback on the parsing process, enhancing user engagement and productivity.

Designed for implementation in a cloud computing environment, the system ensures scalability and provides collaborative features for multiple users to contribute to the parsing process.

This novel approach to adaptive parsing not only addresses the challenges posed by diverse data formats but also sets a new standard for accuracy and efficiency in text data interpretation and structuring.

1. An adaptive parsing system comprising a processor configured to initiate a parsing operation by applying a default delimiter to a text input.

2. The system of claim 1, wherein the processor is further configured to perform a check for extra delimiters not accounted for by the default delimiter.

3. The system of claim 2, wherein the processor adapts the parsing strategy when extra delimiters are detected, employing variable tokens for subsequent parsing operations.

4. The system of claim 3, wherein the variable tokens are based on patterns derived from the occurrences of extra delimiters.

5. The system of claim 4, wherein the processor trims whitespace from the tokens following the adaptive parsing phase.

6. The system of claim 5, wherein the processor identifies the tokens by categorizing them into predefined types.

7. The system of claim 6, wherein the processor handles errors or ambiguities encountered during the parsing process.

8. The system of claim 7, wherein the processor resolves ambiguities by applying a set of heuristic rules.

9. The system of claim 8, wherein the heuristic rules are configurable based on the context of the text input.

10. The system of claim 9, wherein the processor utilizes a machine learning model to predict the category of ambiguous tokens.

11. The system of claim 10, wherein the machine learning model is trained on a dataset of previously parsed tokens.

12. The system of claim 11, wherein the processor provides a user interface for manual correction of parsing errors.

13. The system of claim 12, wherein the user interface includes suggestions for possible corrections based on historical parsing data.

14. The system of claim 13, wherein the processor records user corrections to refine the machine learning model.

15. The system of claim 14, wherein the processor outputs the parsed data in a structured format compatible with database systems.

16. The system of claim 15, wherein the structured format is selectable from a group consisting of JSON, XML, and CSV formats.

17. The system of claim 16, wherein the processor is part of a larger data processing system integrated with data analytics tools.

18. The system of claim 17, wherein the data processing system provides real-time feedback on the parsing process to the user.

19. The system of claim 18, wherein the system is implemented in a cloud computing environment for scalability.

20. The system of claim 19, wherein the cloud computing environment provides collaborative features for multiple users to contribute to the parsing process.
